(19) United States
(12) Patent Application Publication
(10) Pub. No.: US 2021/0281136 A1
(43) Pub. Date: Sep. 9, 2021

(54) Device for generating electricity while reducing restrictive electromotive forces upon a rotor magnet

(71) Applicant: David Joseph, Saskatoon (CA)

(72) Inventor: David Joseph, Saskatoon (CA)

(21) Appl. No.: 16/706,744

(22) Filed: Dec. 7, 2019

(51) Int. Cl. H02K 3/02

(52) U.S. Cl. CPC H02K 3/02

(57) ABSTRACT

The invention as claimed, has utility in that the device generates electricity while reducing restrictive electromagnetic forces acting upon a rotor magnet passing a coil in a complete circuit.

### TECHNICAL FIELD

The present invention relates to generating electricity while reducing restrictive electromagnetic forces acting upon a rotor magnet passing a coil.

### BACKGROUND

An electric generator converts mechanical energy obtained from an external source into electricity. The mechanical energy supplied to magnets housed inside a generator causes the movement of electric charges in the wire of its windings through an external electric circuit. This flow of electric charges creates the output electric current of the generator.

Todays generator works on the principle of electromagnetic induction discovered by Michael Faraday in 1831. Faraday discovered that the flow of electric charges could be induced by moving a wire, in a magnetic field. This movement creates a voltage difference between the two ends of the wire, which causes the electric charges to flow, when the circuit is closed; thereby generating electric current.

The induced magnetic field inside any loop of wire always acts to keep the magnetic flux in the loop constant. If the flux is increasing, the induced field acts in opposition to it. If it is decreasing, the induced field acts in the direction of the applied field to oppose the change. In accordance with Lens Law, the result is that when a generator must increase energy to supply a load, the external mechanical force on the generators rotor must increase in torque.

The embodiments of the present invention are significantly different to that of a standard generator stator. While acting within the known laws of science, including Lens Law, the embodiments of this invention allows for increased current through a coil without significantly increasing torque on the rotor magnet.

### SUMMARY OF INVENTION

The purpose of the embodiments of this invention, is to provide a means to produce electric power with a minimum of mechanical energy. To act within the known laws of science, the embodiments of this invention uses permeable material placed on one end of a coil and bends up the side or sides of the coil and extending to the opposite end of said coil; here referred to as the magnetic conduit. When a magnet passes by the coil it creates a current which causes a magnetic field inside the core of the coil that also extends outside the coil; having the same polarity to the incoming magnets magnetic field, it hinders the mechanical movement of the passing magnet. This same hindrance is again found when the incoming magnet is now outgoing; wherein the magnetic field now attracts the leaving rotor magnet.

The embodiments of this invention, brings the coils magnetic field from one end forward via way of the magnetic conduit to the other end of the coil. Having opposite polarity to that of the incoming magnet, the magnetic conduit adds an attracting counter magnetic force balancing the repulsive magnetic field with the attracting magnetic field of the same coil; wherein both polarities of the coil are acting on the incoming magnet. The same occurs as the magnet leaves the coil; wherein the one magnetic field of the coil attempts to pull the magnet back in and the opposite magnetic field via way of the magnetic conduit attempts to push the magnet out. Once again, these two coil magnetic forces cancel each other out and the rotor magnet passes out of the coil unhindered regardless of the current passing through the coil. Both ends of the coils magnetic fields are equal at all times regardless of drawn current.

The embodiments of the present invention, includes at least one coil, hereby referred to as the stator coil; a magnetic conduit made of permeable material. When the conduit is combined with at least one stator coil in this manor it is hereby referred to as the stator unit.

The preferred embodiments of the present invention, includes at least one permanent magnet, hereby referred to as the rotor magnet attached to a rotor; so, positioned for

one pole of the magnet to pass bye at least one stator unit. The stator coil wires, being attached to a closed circuit produces current in the circuit when a magnet passes bye.

The aforementioned embodiments of the present invention, results in removing hindering magnetic fields upon a magnet moving through and exiting the area of a stator coil; allowing torque on the rotor to be relatively unaffected by increased generated current.

Gas turbine generators, hydro generators, wind generators and all other types of generators; when applying the embodiments of the current invention, would require lower mechanical force, reducing the relative power consumption required to operate the said generator. In the case of wind generators, it would greatly reduce the speed of the wind currents needed while generating high electric current and voltage.

### BRIEF DESCRIPTION OF DRAWINGS

FIG. 1 illustrates the preferred configuration of this present invention showing a side view of the inventions stator unit 316 made up of a coil 3, a magnetic conduit 16 on two opposite sides.

FIG. 2 illustrates the preferred configuration of this present invention showing a side view of a coil 3, magnetic conduit 16 on opposite sides, a magnet 1 spinning on a rotor 2. Magnet 1 S south pole is coming into the area of the stator coil 3 and magnetic conduit 16; whereby the coils 3 right side magnetic field is S South polarity and the left side of the coil 3 is N North polarity; and both top and bottom of the magnetic conduit 16 is N North polarity.

FIG. 3 illustrates the preferred configuration of this present invention showing a side view of a coil 3, magnetic conduit 16 on opposite sides, a magnet 1 spinning on a rotor 2. Magnet 1 S south pole is coming out of the area of the coil 3 and magnetic conduit 16; whereby the coils 3 right side magnetic field is N North polarity and the left side of the coil 3 is S South polarity and both top and bottom of the magnetic conduit 16 is S South polarity.

FIG. 4 illustrates the preferred configuration of this present invention showing a side view of the inventions stator unit 315 made up of a coil 3, a magnetic conduit 15 on one side.

FIG. 5 illustrates the preferred configuration of this present invention showing a side view of a coil 3, magnetic conduit 15 on one side, a magnet 1 spinning on a rotor 2. Magnet 1 S south pole is coming into the area of the coil 3 and magnetic conduit 15; whereby the coils 3 right side magnetic field is S South polarity and the left side of the coil 3 is N North polarity, the magnetic conduit 15 is N North polarity.

FIG. 6 illustrates the preferred configuration of this present invention showing a side view of a coil 3, magnetic conduit 15 on one side, a magnet 1 spinning on a rotor 2. Magnet 1 S south pole is coming out of the area of the coil 3 and magnetic conduit 15; whereby the coils 3 right side magnetic field is N North polarity and the left side of the coil 3 is S South polarity and the magnetic conduit 15 is S South polarity.

FIG. 7 illustrates the preferred configuration of this present invention showing a front view of a coil 3, magnetic conduit 16 on two sides, making up the Stator unit 316.

FIG. 8 illustrates the preferred configuration of this present invention showing a front view of a coil 3, magnetic conduit 15 on one side, making up the Stator unit 315.

### DESCRIPTION OF EMBODIMENTS

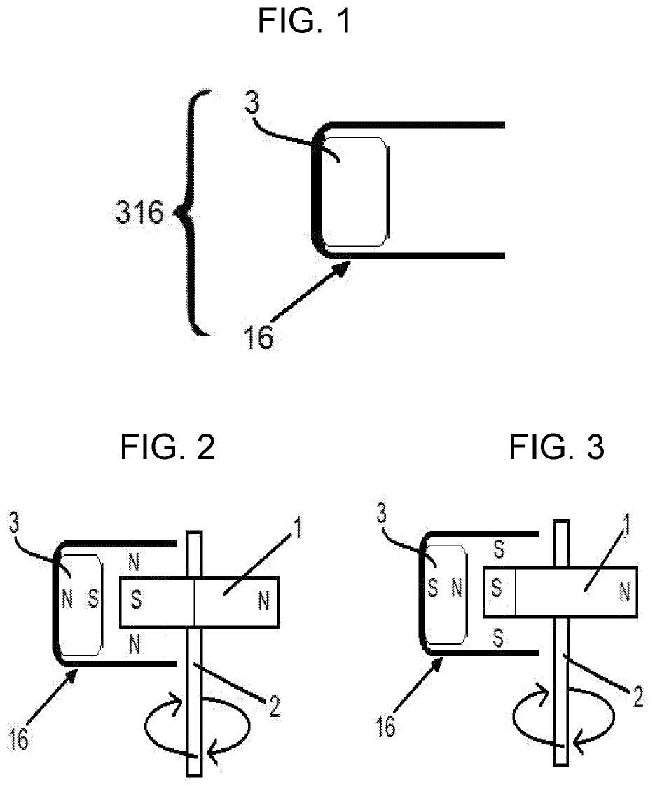

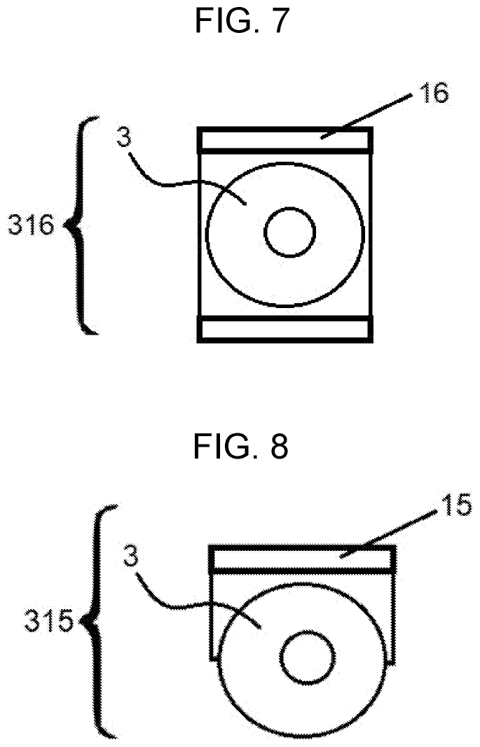

As shown in illustration FIG. 1 and FIG. 7, the invention is a stator unit 316. In its preferred embodiments the present invention has the coil 3 attached to a magnetic field conduit 16. The said magnetic conduit 16 is on both sides of the coil and goes from one end of the coil to the other end of said coil.

As shown in illustration FIG. 2, in its preferred embodiments the present invention has the coil 3 attached to a magnetic field conduit 16. The said magnetic conduit 16 goes from one end of the coil to the other end of said coil. A rotor magnet 1 is attached to a rotor 2. The rotor magnet 1 south pole is moving toward coil 3 and magnetic conduit 16. The coils 3 magnetic field being S south is opposing the rotor magnet 1 field which is also S south; while the magnet conduit 16 has a polarity of N north and is attracting the rotor magnet 1.

As shown in illustration FIG. 3, in its preferred embodiments the present invention has the coil 3 attached to a magnetic field conduit 16. The said magnetic conduit 16 goes from one end of the coil to the other end of said coil. A rotor magnet 1 is attached to a rotor 2. The rotor magnet 1 south pole is moving away from coil 3 and magnetic conduit 16. The coils 3 magnetic field being N north is attracting the rotor magnet 1 field which is S south; while the magnet conduit 16 has a polarity of S South and is repulsing the rotor magnet 1 south pole.

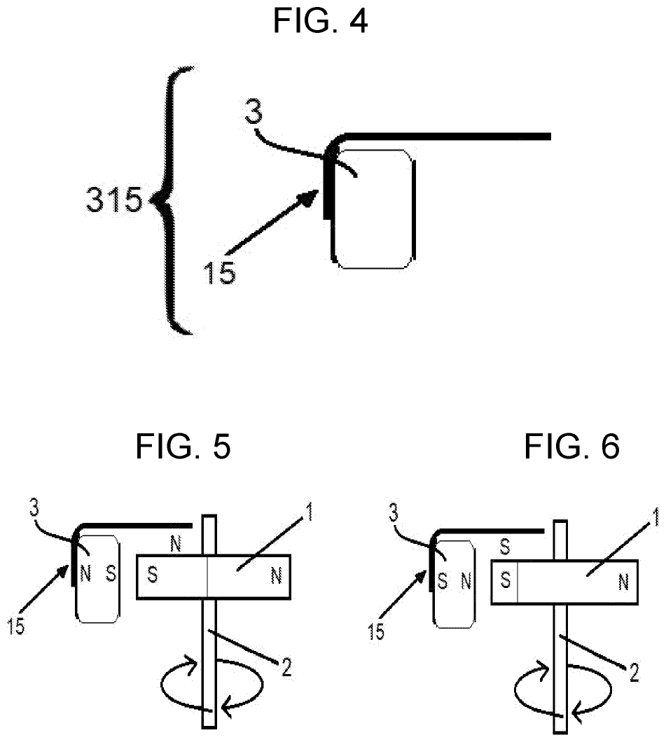

As shown in illustration FIG. 4 and FIG. 8, in an alternate configuration of the current invention is a stator unit 315. An alternate embodiment of the present invention has the coil 3 attached to a magnetic field conduit 15. The said magnetic conduit 15 is on one side of the coil and goes from one end of the coil to the other end of said coil.

As shown in illustration FIG. 4, FIG. 5 and FIG. 6, the invention is a stator unit 315. In an alternate embodiment the present invention has the coil 3 attached to a magnetic field conduit 15. The said magnetic conduit 15 is on one side and goes from one end of the coil to the other end of said coil.

As shown in illustration FIG. 5, in its preferred embodiments the present invention has the coil 3 attached to a magnetic field conduit 15. The said magnetic conduit 15 goes from one end of the coil to the other end of said coil. A rotor magnet 1 is attached to a rotor 2. The rotor magnet 1 south pole is moving toward coil 3 and magnetic conduit 15. The coils 3 magnetic field being S south is opposing the rotor magnet 1 field which is also S south; while the magnet conduit 15 has a polarity of N north and is attracting the rotor magnet 1.

As shown in illustration FIG. 6, in its preferred embodiments the present invention has the coil 3 attached to a magnetic field conduit 15. The said magnetic conduit 15 is on one side and goes from one end of the coil to the other end of said coil. A rotor magnet 1 is attached to a rotor 2. The rotor magnet 1 south pole is moving away from coil 3 and magnetic conduit 15. The coils 3 magnetic field being N north is attracting the rotor magnet 1 field which has a polarity of S south; while the magnet conduit 15 has a polarity of S South and is repulsing the rotor magnet 1 south pole.

1) An electricity generating, reducing restrictive magnetic force device comprising;
at least one coil of wire;
at least one permeable material structure which starts at one end of a coil and extends along at least one side toward the opposite end of said coil;
at least one rotor magnet attached to a rotor.
